(19) United States
(12) Patent Application Publication
(10) Pub. No.: US 2025/0385778 A1
(43) Pub. Date: Dec. 18, 2025

(54) PAM-2N SYSTEM HAVING OPTIMIZED CLOCK DATA RECOVERY CHARACTERISTIC

(71) Applicant: KUMOH NATIONAL INSTITUTE OF TECHNOLOGY INDUSTRY-ACADEMIC COOPERATION FOUNDATION, Gumi-si (KR)

(72) Inventors: Young-Chan JANG, Gumi-si (KR); Chang-Min SONG, Gimcheon-si (KR)

(73) Assignee: KUMOH NATIONAL INSTITUTE OF TECHNOLOGY INDUSTRY-ACADEMIC COOPERATION FOUNDATION, Gumi-si (KR)

(21) Appl. No.: 19/177,232

(22) Filed: Apr. 11, 2025

(30) Foreign Application Priority Data
Jun. 18, 2024 (KR) 10-2024-0079091

(51) Int. Cl. H04L 7/033; H04L 25/49

(52) U.S. Cl. CPC H04L 7/033; H04L 25/4917

(57) ABSTRACT

Proposed is a PAM-2^{N} system which can support a training pattern and has an optimized clock data recovery characteristic through data encoding. The PAM-2^{N} system having an optimized clock data recovery characteristic includes a receiver, a de-serializer, a data encoder, a PAM-2^{N} transmitter, a PAM-2^{N} receiver, a CDR, and a serializer & transmitter.

### CROSS REFERENCE TO RELATED APPLICATION(S)

This application claims priority to and benefit of Korean Patent Application No. 10-2024-0079091 under 35 U.S.C. § 119, filed on Jun. 18, 2024 in the Korean Intellectual Property Office, the entire contents of which are incorporated herein by reference.

### BACKGROUND

### 1. Technical Field

The present disclosure relates to a pulse amplitude modulation (PAM) system, and particularly, to a square-of-N-of-PAM 2 (hereinafter referred to as a “PAM-2^{N}”) system which can support a training pattern and has an optimized clock data recovery characteristic through data encoding.

### 2. Related Art

From a viewpoint of the transmission and reception of data, it will be preferred and efficient to transmit a larger amount of data at a faster speed when data (or signals) are transmitted and received between two points. For example, in order to double the data rate between two points, a channel or a lane through which data are transmitted may be added. In this case, in addition to adding one channel to the existing one channel, that is, the transfer path of data, a transmitter and a receiver that are included in the added channel will be additionally required. An increase of consumption power attributable to the added transmitter and receiver becomes a disadvantage of a method of simply adding a channel.

In order to solve the disadvantage of the method of adding a channel, there is suggested that two bit streams are serialized. Such a suggestion also has a problem in that the bandwidth of a signal is doubled.

In order to supplement the disadvantage when the two bit streams are serialized, there is suggested a PAM-4 method. PAM-4 is to divide a least significant bit (LSB) signal by half and add the divided signals to a most significant bit (MSB) signal. As a result, the number of levels of a signal that is transmitted and received is four levels not two levels. Two levels including 0 and 1 may be implemented in one bit, whereas four levels may be implemented in two bits like 00, 01, 10, and 11. Assuming that one bit and two bits are transmitted at the same speed, the amount of data transmitted at the same time will be two times in the four levels compared to the two levels.

Recently, in a high speed interface, in order to reduce the number of pins of a package, a clock and data recovery (CDR) technology is used. The reason for this is that the number of clock lanes can be reduced by using the CDR technology.

In the CDR technology, a clock having a frequency that is matched with a data rate is generated by receiving a training pattern (or a toggling pattern) signal and random data and generating 1-unit interval information of data from the toggling of the received data. However, the CDR technology may have a problem in that the frequency of a clock CLK is different from the transfer rate (i.e., frequency) of received data because data information is not updated if the received data maintain the same DC (Direct Current) value, that is, “0” or “1”, for a predetermined time.

In order to solve such a problem, in an application in which CDR is used, in order to generate DC-balanced data of “0” and “1”, an 8-bit/10-bit encoding scheme is adopted and used.

FIG. 1 illustrates a block diagram of a conventional PAM-4 system.

Referring to FIG. 1, a conventional PAM-4 system 100 includes a receiver 110, a PLL 120, a de-serializer 130, a PAM-4 transmitter 140, a PAM-4 receiver 150, a half-rate CDR 160, and a serializer & transmitter 170.

The receiver 110 converts received two serial input data IN_{P} and IN_{M} that have been subjected to 8B/10B encoding into 10-bit serial data Dix in which the MSBs and LSBs of the two serial input data IN_{P} and IN_{M} have been alternately aligned. The 10-bit serial data D_{IN} have a form of MSB0, LSB0, MSB1, LSB1 to MSB4, and LSB4, for example.

The de-serializer 130 converts the serial data D_{IN} into 2-bit de-serialized data D_{MSB} and D_{LSB} by classifying and aligning the serial data D_{IN} into the MSBs and the LSBs by using a clock CLK that is generated by the PLL 120. The first 2-bit de-serialized data D_{MSB} have a form of MSB0, MSB1, MSB2, MSB3, and MSB4. The second 2-bit de-serialized data D_{LSB} have a form of LSB0, LSB1, LSB2, LSB3, and LSB4.

The PAM-4 transmitter 140 generates two transmission data TX_{OP} and TX_{OM} having four levels by using the 2-bit de-serialized data D_{MSB} and D_{LSB}.

The PAM-4 receiver 150 generates 3-bit data D_{H}, D_{M}, and D_{L} by using the received two transmission data TX_{OP} and TX_{OM}.

The half-rate CDR 160 generates 6-bit data D_{H_MSB}, D_{H_LSB}, D_{M_MSB}, D_{M_LSB}, D_{L_MSB}, and D_{L_LSB} by using the 3-bit data D_{H}, D_{M}, and D_{L}.

The serializer & transmitter 170 serializes the 6-bit data D_{H_MSB}, D_{H_LSB}, D_{M_MSB}, D_{M_LSB}, D_{L_MSB}, and D_{L_LSB} into two output data TX_{OP2} and TX_{OM2}.

FIG. 2 illustrates a timing diagram of the conventional PAM-4 system.

Referring to FIG. 2, it may be seen that in the conventional PAM-4 system 100, the two serial input data IN_{P} and IN_{M} that are received by the receiver 110 have a toggle pattern, that is, representative DC-balanced data. Black and gray data illustrate the two serial input data IN_{P} and IN_{M}, respectively. The receiver 110 generates the serial data DI in which the MSBs and LSBs of the received two serial input data IN_{P} and IN_{M} have been alternately aligned.

The de-serializer 130 converts the serial data D_{IN} into the first 2-bit de-serialized data D_{MSB} and D_{LSB} by synchronizing the serial data D_{IN} with the clock CLK received from the PLL 120. As illustrated in FIG. 2, a case in which the first 2-bit de-serialized data D_{MSB} outputs only a value of “1” and the second 2-bit de-serialized data D_{LSB} outputs a DC value of “0” is assumed for convenience of description.

The PAM-4 transmitter 140 converts the 2-bit de-serialized data D_{MSB} and D_{LSB} into the two transmission data TX_{OP} and TX_{OM} having four levels.

The PAM-4 receiver 150 receives the two transmitted data TX_{OP} and TX_{OM} and converts the two transmitted data TX_{OP} and TX_{OM} into the three 3-bit data D_{H}, D_{M}, and D_{L}.

The half-rate CDR 160 converts the 3-bit data D_{H}, D_{M}, and D_{L} into the 6-bit data D_{H_MSB}, D_{H_LSB}, D_{M_MSB}, D_{M_LSB}, D_{L_MSB}, and D_{L_LSB}.

Referring to FIG. 2, the half-rate CDR 160 cannot perform a normal operation because all of the two transmitted data TX_{OP} and TX_{OM} and the 3-bit data D_{H}, D_{M}, and D_{L} have the same DC value of “1” or “0” for a predetermined time. Accordingly, CDR can not generate a clock that matches the data rate.

As a result, the two output data signals TX_{OP2} and TX_{OM2} will each be a data signal that cannot be modulated into data values having the two serial input data signals IN_{P} and IN_{M} as a target.

### PRIOR ART DOCUMENT

### Patent Document

Korean Patent Application Publication No. 10-2024-0000229 (Jan. 2, 2024)

### SUMMARY

Various embodiments are directed to providing a PAM-2^{N} system which can support a training pattern and has an optimized clock data recovery characteristic through data encoding.

Technical objects to be achieved by the present disclosure are not limited to the aforementioned object, and the other objects not described above may be evidently understood from the following description by a person having ordinary knowledge in the art to which the present disclosure pertains.

In an embodiment, a PAM-2^{N} system having an optimized clock data recovery characteristic may include a receiver, a de-serializer, a data encoder, a PAM-2^{N} transmitter, a PAM-2^{N} receiver, and a CDR.

The receiver converts received serial input data into serial data in which the MSBs and LSBs of the received serial input data have been alternately aligned. The de-serializer converts the serial data into N (N is a natural number equal to or greater than 2)-bit de-serialized data based on a clock. The data encoder generates N-bit encoded de-serialized data by encoding the N-bit de-serialized data. The PAM-2^{N} transmitter generates a differential signal by using the N-bit encoded de-serialized data. The PAM-2^{N} receiver generates (2^{N}−1)-bit data by receiving the differential signal. The CDR uses the (2^{N}−1)-bit data.

Technical objects to be achieved by the present disclosure are not limited to the aforementioned object, and the other objects not described above may be evidently understood from the following description by a person having ordinary knowledge in the art to which the present disclosure pertains.

The PAM-2^{N} system having an optimized clock data recovery characteristic according to the embodiment of the present disclosure has advantages in that it can support a training pattern and can improve a clock data recovery characteristic by supplying improved DC-balanced data to the CDR even in random data.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 illustrates a block diagram of a conventional PAM-4 system.

FIG. 2 illustrates a timing diagram of the conventional PAM-4 system.

FIG. 3 illustrates a block diagram of a PAM-2^{N} system having an optimized clock data recovery characteristic according to an embodiment of the present disclosure.

FIG. 4 illustrates a block diagram of a data encoder.

FIG. 5 illustrates a timing diagram of the PAM-2^{N} system according to an embodiment of the present disclosure.

FIGS. 6A, 6B, and 6C illustrate a timing diagram of the data encoder.

FIGS. 7A and 7B illustrate computer simulation results of the repetition number of data before and after the data encoder is applied.

### DETAILED DESCRIPTION

In order to sufficiently understand the present disclosure, operational advantages of the present disclosure, and an object achieved by carrying out the present disclosure, reference needs to be made to the accompanying drawings illustrating embodiments of the present disclosure and contents described with reference to the accompanying drawings.

Hereinafter, embodiments of the present disclosure are described in detail with reference to the accompanying drawings. The same reference numerals presented in the drawings refer to the same members.

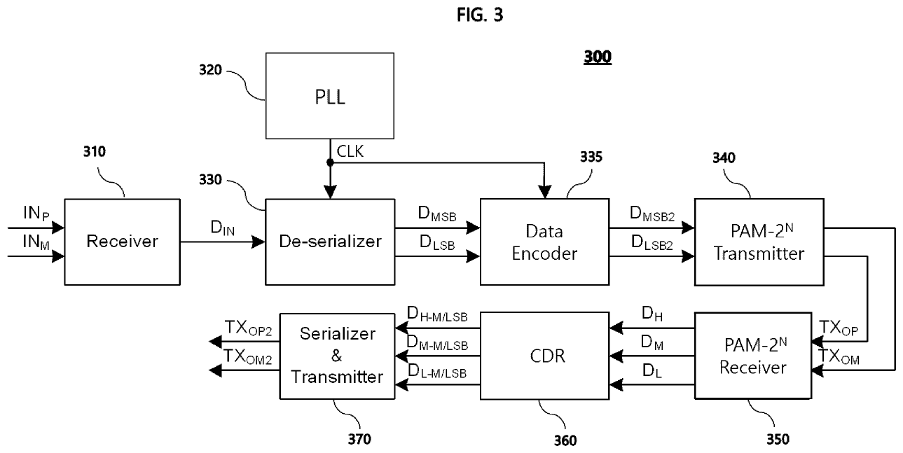

FIG. 3 illustrates a block diagram of a PAM-2^{N} system having an optimized clock data recovery characteristic according to an embodiment of the present disclosure.

Referring to FIG. 3, a PAM-2^{N} system 300 (N is a natural number equal to or greater than 2) having an optimized clock data recovery characteristic according to an embodiment of the present disclosure includes a receiver 310, a PLL 320, a de-serializer 330, a data encoder 335, a PAM-2^{N} transmitter 340, a PAM-2^{N} receiver 350, a half-rate CDR 360, and a serializer & transmitter 370.

Hereinafter, PAM-4 in which N is 2 is described as an example, but it is not difficult for those skilled in the field to apply the above description to an embodiment in which Nis 3 or more.

The receiver 310 receives two serial input data IN_{P} and IN_{M} that have been subjected to 8B/10B encoding, and converts the received two serial input data IN_{P} and IN_{M} into serial data D_{IN} in which the MSBs and LSBs of the two serial input data IN_{P} and IN_{M} have been alternately aligned.

The de-serializer 330 converts the serial data D_{IN} into 2-bit de-serialized data D_{MSB} and D_{LSB} by using a clock CLK that is generated by the PLL 320.

The data encoder 335 generates encoded 2-bit-encoded de-serialized data D_{MSB2} and D_{LSB2} by encoding the 2-bit de-serialized data D_{MSB} and D_{LSB}.

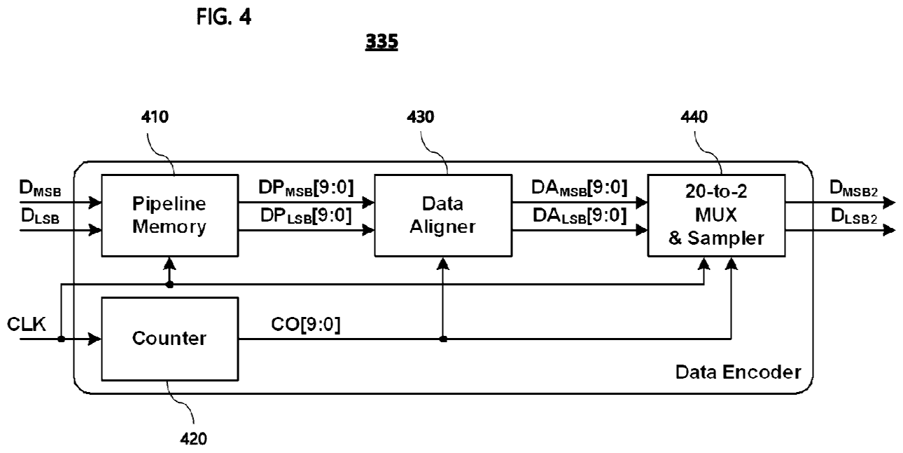

FIG. 4 illustrates a block diagram of the data encoder.

Referring to FIG. 4, the data encoder 335 includes pipeline memory 410, a counter 420, a data aligner 430, and a multiplexer (MUX) & sampler 440.

The pipeline memory 410 stores the 2-bit de-serialized data D_{MSB} and D_{LSB} received from the de-serializer 330, classifies and samples the MSBs and LSBs of the 2-bit de-serialized data D_{MSB} and D_{LSB} based on a clock CLK that is generated by PLL, and outputs a 10-bit MSB DP_{MSB}[9:0] and a 10-bit LSB DP_{LSB}[9:0] by aligning the sampled MSBs and LSBs of the 2-bit de-serialized data D_{MSB} and D_{LSB}. Accordingly, the 10-bit MSB DP_{MSB}[9:0] and the 10-bit LSB DP_{LSB}[9:0] have a phase difference of one cycle of the clock CLK from the 2-bit de-serialized data D_{MSB} and D_{LSB}.

The counter 420 generates a clock count signal CO[9:0], that is, a pulse signal having a duty of 10%, by dividing the clock CLK from the PLL 320 by 10.

The data aligner 430 generates an aligned 10-bit MSB DA_{MSB}[9:0] and an aligned 10-bit LSB DA_{LSB}[9:0] in which the 10-bit MSB DP_{MSB}[9:0] and the 10-bit LSB DP_{LSB}[9:0] have been aligned based on the clock count signal CO[9:0] in order to match the timing of data with the clock CLK.

The MUX & sampler 440 includes a 20-to-2 MUX (not illustrated) (hereinafter referred to as a “multiplexer”) and a sampler (not illustrated). A MUX generates the 2-bit-encoded de-serialized data D_{MSB2} and D_{LSB2} by multiplexing the aligned 10-bit MSB DA_{MSB}[9:0] and the aligned 10-bit LSB DA_{LSB}[9:0] based on the clock CLK and the clock count signal CO[9:0] and then sampling the multiplexed aligned 10-bit MSB DA_{MSB}[9:0] and aligned 10-bit LSB DA_{LSB}[9:0] through the sampler (not illustrated).

Accordingly, the first encoded 2-bit de-serialized data D_{MSB2} that have been encoded from the 2-bit de-serialized data D_{MSB} and D_{LSB} in order of {MSB0, LSB0, . . . , MSB4, LSB4} through the data encoder 335 are output. Next, the second encoded 2-bit de-serialized data D_{LSB2} that have been encoded from the 2-bit de-serialized data D_{MSB} and D_{LSB} in order of {MSB5, LSB5, . . . , MSB9, LSB9} are output.

Subsequent 2-bit de-serialized data D_{MSB} and D_{LSB} are also output as the 2-bit-encoded de-serialized data D_{MSB2} and D_{LSB2}. The reason why data are encoded by dividing the data every 10 bits is that the 8B/10B encoding scheme has DC balance on the basis of 10 bits. If data are encoded as described above, the input of the half-rate CDR will become a toggle pattern like the input of the de-serializer 330.

The PAM-2˜ transmitter 340 generates two transmission data TX_{OP} and TX_{OM}, that is, a differential signal having four levels, by using the 2-bit-encoded de-serialized data D_{MSB2} and D_{LSB2}.

The PAM-2^{N} receiver 350 generates (2-1)-bit data D_{H}, D_{M}, and D_{L}, by receiving the two transmitted data TX_{OP} and TX_{OM}, that is, a differential signal.

The CDR 360 generates 6-bit data D_{H_MSB}, D_{H_LSB}, D_{M_MSB}, D_{M_LSB}, D_{L_MSB}, and D_{L_LSB}.

The serializer & transmitter 370 serializes the 6-bit data D_{H_MSB}, D_{H_LSB}, D_{M_MSB}, D_{M_LSB}, D_{L_MSB}, and D_{L_LSB} into two output data TX_{OP2} and TX_{OM2}.

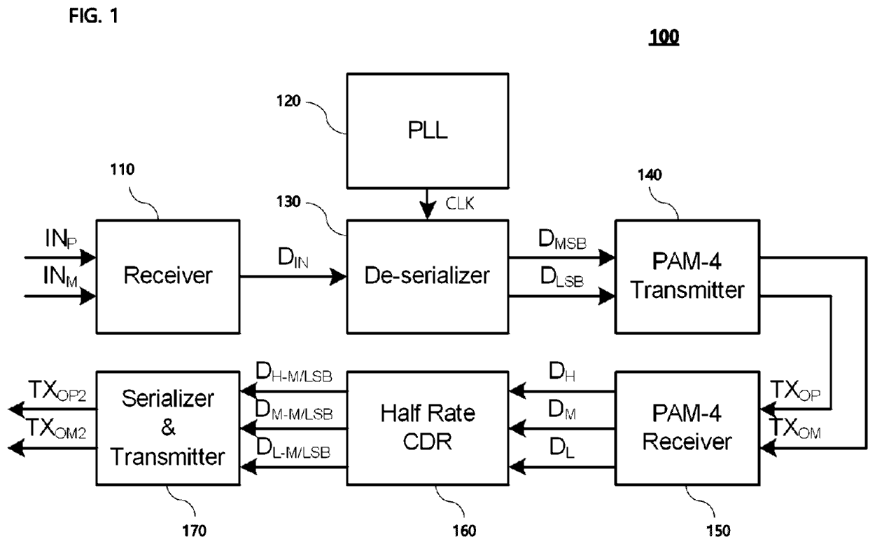

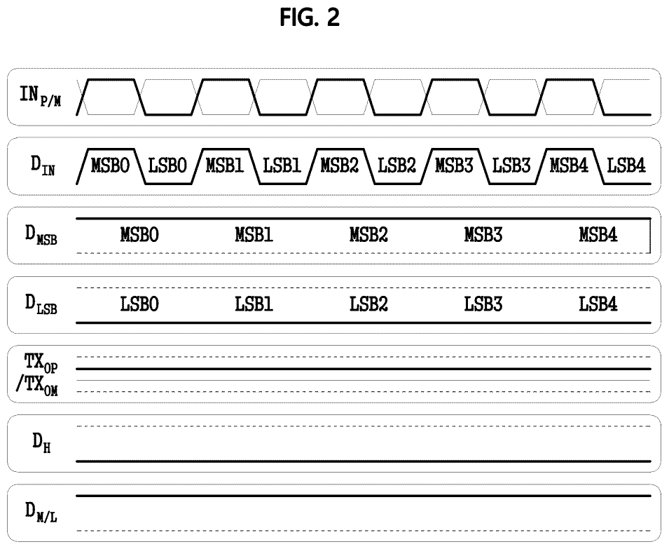

The construction of the PAM-2^{N} system 300 illustrated in FIG. 3 according to an embodiment of the present disclosure and the construction of the conventional PAM-4 system 100 illustrated in FIG. 1 are the same except the data encoder 335. When the timing diagram of the PAM-2^{N} system 300 illustrated in FIG. 3 is described, a description of signals that are redundant with those of the timing diagram of the conventional PAM-4 system 100 illustrated in FIG. 2 is omitted, and only an added signal and a signal having a different level are described.

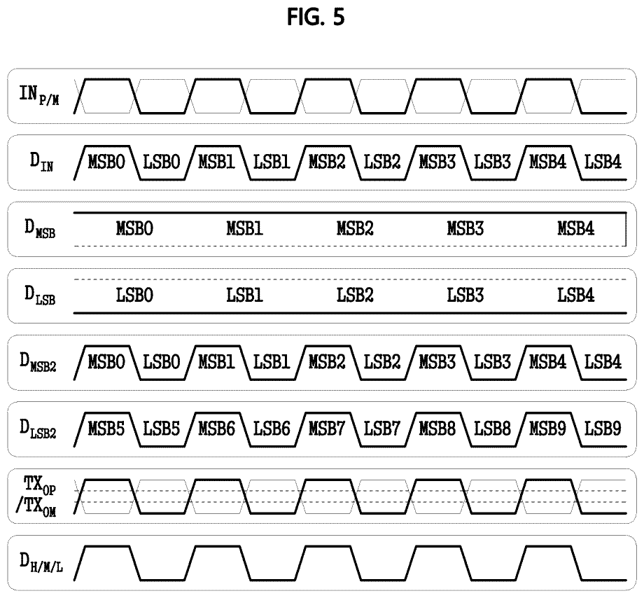

FIG. 5 illustrates a timing diagram of the PAM-2^{N} system according to an embodiment of the present disclosure.

In the timing diagram illustrated in FIG. 5, characteristics of the timing diagrams of the receiver 410, the PLL 420, and the de-serializer 330 are substituted with the description of the timing diagram illustrated in FIG. 2.

Referring to FIG. 5, the first 2-bit-encoded de-serialized data D_{MSB2}, among the 2-bit-encoded de-serialized data D_{MSB2} and D_{LSB2} that are generated by the data encoder 335, are 10-bit MSB0, LSB0 to MSB4, and LSB4 in which the MSBs and the LSBs, that is, upper five bits of the 10-bit MSBs and the LSBs, have been alternately aligned. The second 2-bit-encoded de-serialized data D_{LSB2}, among the 2-bit-encoded de-serialized data D_{MSB2} and D_{LSB2} that are generated by the data encoder 335, are 10-bit MSB5, LSB5 to MSB9, and LSB9 in which the MSBs and the LSBs, that is, lower five bits of the 10-bit MSBs and the LSBs, have been alternately aligned.

Each of the 10-bit first 2-bit-encoded de-serialized data D_{MSB2} and the 10-bit second 2-bit-encoded de-serialized data D_{LSB2} includes toggling data. Accordingly, the 2-bit de-serialized data D_{MSB} and D_{LSB} that are output from the de-serializer 330 become the two transmission data TX_{OP} and TX_{OM}, that is, a differential signal having four levels, through the data encoder 335 and the PAM-2^{N} transmitter 340.

The PAM-2^{N} receiver 350 generates the (2^{N}−1)-bit data D_{H}, D_{M}, and D_{L}, by receiving the two transmitted data TX_{OP} and TX_{OM}, that is, a differential signal.

The CDR 360 generates the 6-bit data D_{H_MSB}, D_{H_LSB}, D_{M_MSB}, D_{M_LSB}, D_{L_MSB}, and D_{L_LSB}, by using the (2^{N}−1)-bit data D_{H}, D_{M}, and D_{L}.

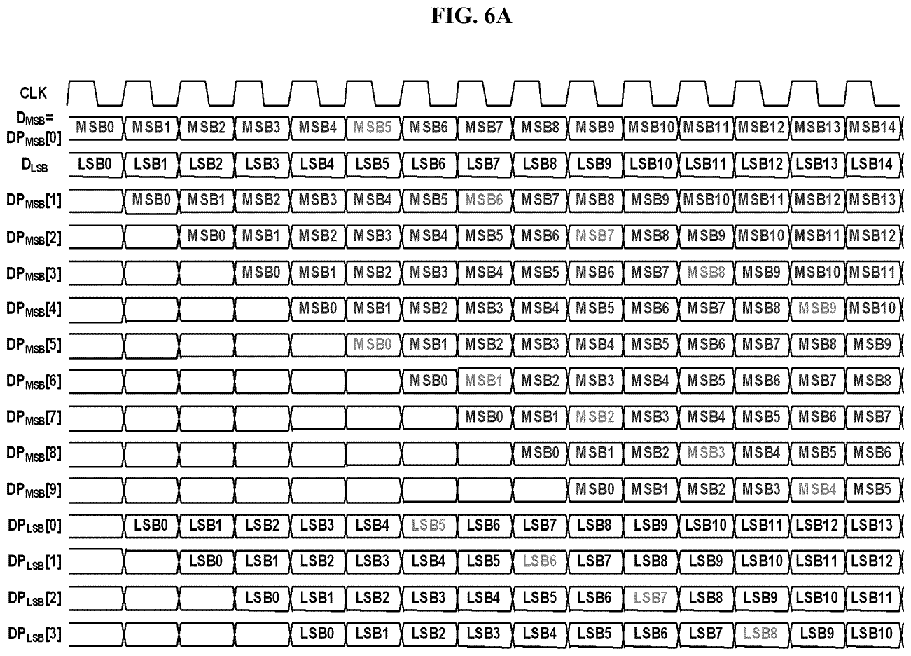

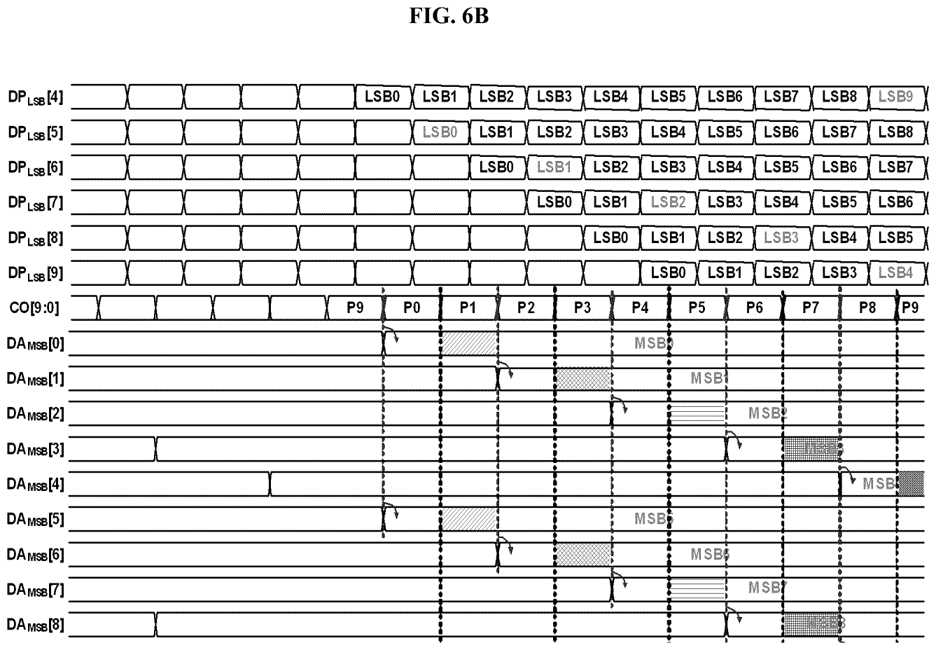

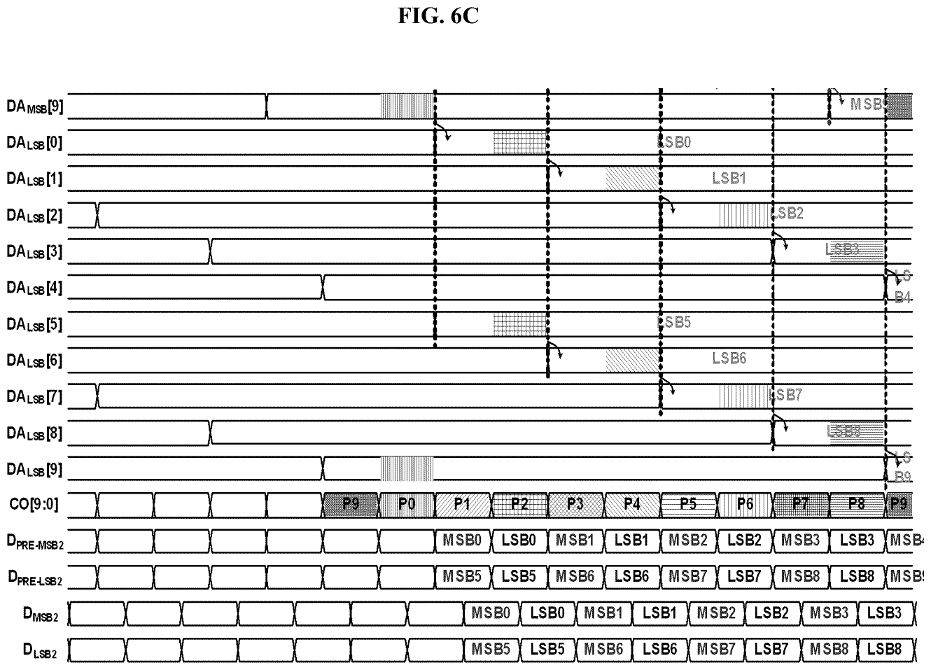

FIG. 6A to 6C illustrate a timing diagram of the data encoder.

Referring to FIGS. 4 and 6, the pipeline memory 410 generates 10-bit parallel data (i.e., the 10-bit MSB DP_{MSB}[9:0] and the 10-bit LSB DP_{LSB}[9:0]) in which the phase of DP[N+1] is more delayed than DP[N] by one cycle by using the clock CLK. In this case, the 10-bit MSB DP_{MSB}[0] uses the 2-bit de-serialized data D_{MSB}, that is, an input data signal, without any change. The LSB signal DP_{LSB} is also generated by delaying the D_{LSB} by one clock cycle in the same way.

The data aligner 430 generates the aligned MSB DA_{MSB}[0] by sampling the MSB0 of the MSB DP_{MSB}[5] by using the clock count signal CO[0], and generates the aligned MSB signal DA_{MSB}[1] by sampling the MSB1 of the MSB DP_{MSB}[6] by using the clock count signal CO[2]. In the same way, the aligned MSB DA_{MSB}[9:0] and the aligned LSB DA_{LSB}[9:0] are generated.

The multiplexer 440 selects the aligned MSB DA_{MSB}[9:0] and the aligned LSB DA_{LSB}[9:0] based on the clock count signal CO[9:0], and converts the 10-bit parallel data signal into a 1-bit serial data signal. The multiplexer 440 selects the aligned MSB DA_{MSB}[0] based on the clock count signal CO[1] and outputs the selected aligned MSB DA_{MSB}[0] as data D_{PRE-MSB2}, and selects the aligned MSB DA_{MSB}[1] based on the clock count signal CO[3] and outputs the selected aligned MSB DA_{MSB}[1] as data D_{PRE-MSB2}. In the same way, the 10-bit aligned MSB DA_{MSB}[9:0] and the aligned LSB DA_{LSB}[9:0] are converted into serial data D_{PRE-MSB2} and D_{PRE-LSB2}, respectively. The serialized data D_{PRE-MSB2} and D_{PRE-LSB2} are output as the 2-bit-encoded de-serialized data D_{MSB2} and D_{LSB2} through the sampler 440.

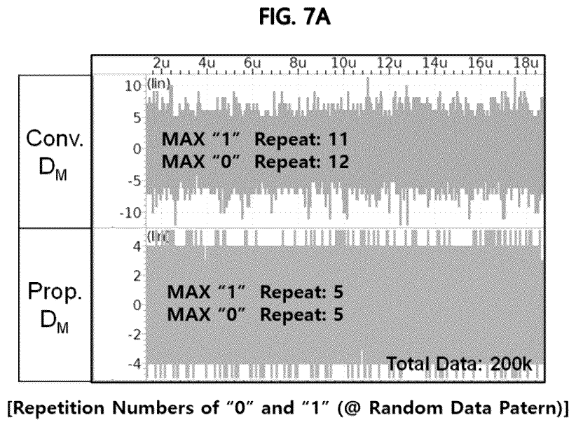

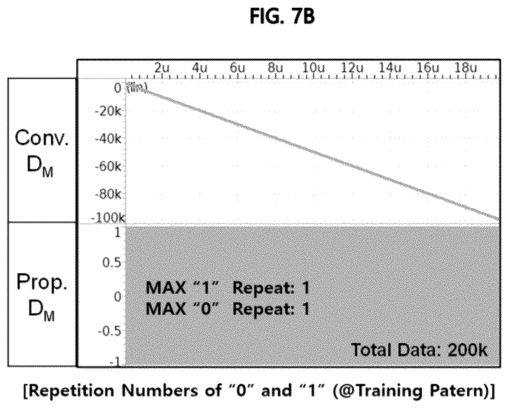

FIG. 7A to 7B illustrate computer simulation results of the repetition number of data before and after the data encoder is applied.

FIG. 7A illustrates computer simulation results before random data were applied to the data encoder 335 (Conv. D_{M}) and after the random data were applied to the data encoder 335 (Prop. D_{M}).

Referring to FIG. 7A, it may be seen that before the random data were applied to the data encoder 335, a maximum repetition number of data “1” was measured as “11”, a maximum repetition number of “0” was measured as “12”. In contrast, it may be seen that after the random data were applied to the data encoder 335, maximum repetition numbers of both “1” and “0” were measured as “5”, which were reduced compared to the case in which the data encoder 335 was applied.

FIG. 7B illustrates computer simulation results before a training pattern was applied to the data encoder 335 (Conv. D_{M}) and after the training pattern was applied to the data encoder 335 (Prop. D_{M}).

Referring to FIG. 7B, before the training pattern was applied to the data encoder 335, results in which a maximum repetition number continued to be increased were obtained because the training pattern was modified into DC data. In contrast, after the training pattern was applied to the data encoder 335, a maximum repetition number was measured as “1” because the training pattern was converted into a toggle pattern.

Accordingly, if the data encoder 335 proposed by an embodiment of the present disclosure is used, there are advantages in that the PAM4 system can support a training pattern and a clock data recovery characteristic can be improved because improved DC-balanced data are supplied to the half-rate CDR 360 even in random data.

The above description has been given with respect to only PAM-4, for example, in order to facilitate the understanding of the technology of the present disclosure. It is evident to those skilled in the art that the above description may be extended and applied to PAM-8 in which N is 3 and PAM-16 in which N is 4.

In particular, as the PAM-2^{N} system is recently applied to the automobile and semiconductor fields, room for the PAM-2^{N} system to expand across the industry is inexhaustible. The present disclosure has been invented and though out as the research results of an industry-academic joint technology development project for regional industry-based talent development and innovative technology development project “Development of MIPI D-/A-PHY-supported CMOS transmission bridge chip and FPGA-based frame generator”.

The aforementioned present disclosure may be implemented in a medium on which a program has been recorded as a computer-readable code. The computer-readable medium includes all types of recording media in which data readable by a computer system is stored. Examples of the computer-readable medium include a hard disk drive (HDD), a solid state disk (SDD), a silicon disk drive (SDD), ROM, RAM, CD-ROM, a magnetic tape, a floppy disk, and an optical data storage device.

The technical spirit of the present disclosure has been described along with the accompanying drawings, but this exemplarily describes preferred embodiments of the present disclosure and is not intended to limit the present disclosure. Furthermore, it is evident that any person having ordinary knowledge in the field to which the present disclosure pertains may modify and imitate the present disclosure without departing from the category of the technical spirit of the present disclosure.

What is claimed is:

1. A pulse amplitude modulation (PAM)-2^{N} system comprising:
a receiver configured to convert received serial input data into serial data in which most significant bits (MSBs) and least significant bits (LSBs) of the received serial input data have been alternately aligned;
a de-serializer configured to convert the serial data into N-bit (N is a natural number equal to or greater than 2) de-serialized data by using a clock;
a data encoder configured to generate N-bit encoded de-serialized data by encoding the N-bit de-serialized data;
a PAM-2^{N} transmitter configured to generate a differential signal by using the N-bit encoded de-serialized data;
a PAM-2^{N} receiver configured to generate (2^{N}−1)-bit data by receiving the differential signal; and
a CDR using the (2^{N}−1)-bit data.

2. The PAM-2^{N} system of claim 1, wherein the data encoder encodes the N-bit encoded de-serialized data to have a toggle pattern although the N-bit de-serialized data have an identical DC value.

3. The PAM-2^{N} system of claim 2, wherein the data encoder comprises:
pipeline memory configured to store the N-bit de-serialized data, classify and sample MSBs and LSBs from the N-bit de-serialized data based on the clock, and then output a 10-bit MSB and a 10-bit LSB by aligning the sampled MSBs and LSBs;
a counter configured to generate a clock count signal based on the clock;
a data aligner configured to generate an aligned 10-bit MSB and an aligned 10-bit LSB in which the 10-bit MSB and the 10-bit LSB have been aligned to be matched with the clock count signal; and
a multiplexer (MUX) & sampler configured to generate the N-bit encoded de-serialized data by using the aligned 10-bit MSB and the aligned 10-bit LSB based on the clock and the clock count signal.

4. The PAM-2^{N} system of claim 3, wherein the MUX & sampler comprises:
a MUX configured to multiplex the aligned 10-bit MSB and the aligned 10-bit LSB based on the clock and the clock count signal; and
a sampler configured to generate the N-bit encoded de-serialized data by sampling an output of the MUX.

5. The PAM-2^{N} system of claim 3, wherein the 10-bit MSB and the 10-bit LSB have a phase difference of one cycle of the clock from the N-bit de-serialized data.

6. The PAM-2^{N} system of claim 3, wherein the clock count signal is a pulse signal having a duty of 10% by dividing the clock by 10.

7. The PAM-2^{N} system of claim 1, further comprising a PLL configured to generate the clock.

8. The PAM-2^{N} system of claim 1, wherein the two transmisstted data have 2^{N} levels.
